(19) United States
(12) Patent Application Publication
(10) Pub. No.: US 2025/0306407 A1
(43) Pub. Date: Oct. 2, 2025

(54) OPTICAL SEMICONDUCTOR DEVICE

(71) Applicant: Lumentum Operations LLC, San Jose, CA (US)

(72) Inventors: Takanori SUZUKI, Hachioji (JP); Shuhei OHNO, Sagamihara (JP); Shunya YAMAUCHI, Sagamihara (JP); Yoshihiro KOJIMA, Sagamihara (JP); Hideaki ASAKURA, Sagamihara (JP); Tetsuyoshi TAKAMURE, Sagamihara (JP)

(21) Appl. No.: 18/902,616

(22) Filed: Sep. 30, 2024

(30) Foreign Application Priority Data
Mar. 28, 2024 (JP) 2024054040
Jul. 8, 2024 (JP) 2024109413

(51) Int. Cl. G02F 1/025

(52) U.S. Cl. CPC G02F 1/025; G02F 2201/12

(57) ABSTRACT

Provided is an optical semiconductor device that has an excellent characteristic. The optical semiconductor device includes: a modulator unit including first and second conductivity type semiconductor layers; a waveguide unit; a first electrode connected to the first conductivity type semiconductor layer; and a second electrode connected to the second conductivity type semiconductor layer. The first electrode includes a first pad electrode. The second electrode includes a second pad electrode. A differential signal is input to the first pad electrode and the second pad electrode. One of at least a part of the first pad electrode or at least a part of the second pad electrode is arranged in the waveguide unit in plan view. The first pad electrode and the second pad electrode are arranged with an offset in positions in a traveling direction of an optical path of the waveguide unit.

### CROSS-REFERENCE TO RELATED APPLICATION

This Patent Application claims priority to Japan Patent Application No. JP2024-109413, filed on Jul. 8, 2024, and Japan Patent Application No. JP2024-054040, filed on Mar. 28, 2024. The disclosure of the prior Applications are considered part of and are incorporated by reference into this Patent Application.

### TECHNICAL FIELD

The present disclosure relates generally to an optical semiconductor device.

### BACKGROUND

An optical semiconductor device used in optical communication includes an optical functional layer at which light emission, absorption, or the like is performed, and two electrodes for inputting electric signals to the optical functional layer. An optical semiconductor device can including two electrodes that are arranged on the same surface of a semiconductor substrate.

### SUMMARY

In a modulator, an anode electrode and a cathode electrode to which differential electric signals are input can be formed on a same surface. Further, a transmission line through which a differential signal is transmitted is arranged on one side surface side of the modulator. A pair of transmission lines forming a differential transmission line and the two electrodes of the modulator are connected by corresponding wires. The two electrodes of the modulator are arranged at positions opposed to each other with respect to a ridge waveguide. Accordingly, the two wires each connecting the differential transmission line and the electrode of the modulator to each other have a great difference in length from each other. A similar problem occurs even when the differential transmission line and the electrode of the modulator are connected to each other by means other than a wire.

When the modulator is driven by a differential signal, it is sometimes preferred that an impedance on the positive phase side and an impedance on the negative phase side be as close as possible to each other. A length of a path between the transmission line and the electrode affects the impedance, and also strongly affects characteristics, in particular, high-frequency characteristics, of the modulator. Accordingly, a great difference in length of the path between the positive phase side and the negative phase side is often not preferred in terms of characteristics in the modulator that performs differential drive.

The present invention has an object to provide an optical semiconductor device that has an excellent characteristic.

In some implementations, an optical semiconductor device includes: a modulator unit including a first conductivity type semiconductor layer, an optical functional layer, and a second conductivity type semiconductor layer which are provided above a substrate; a waveguide unit which is optically connected to the modulator unit, and is arranged integrally in the substrate; a first electrode connected to the first conductivity type semiconductor layer; and a second electrode connected to the second conductivity type semiconductor layer. The first electrode includes a first pad electrode to and/or from which an electric signal of one of a pair of differential signals is to be input and/or output. The second electrode includes a second pad electrode to and/or from which an electric signal of another one of the pair of differential signals is to be input and/or output. One of at least a part of the first pad electrode or at least a part of the second pad electrode is arranged in the waveguide unit in plan view. The first pad electrode and the second pad electrode are arranged with an offset in positions in a traveling direction of an optical path of the waveguide unit.

### BRIEF DESCRIPTION OF THE DRAWINGS

FIG. 1 is a top view of an optical semiconductor device according to a first example implementation of the present invention.

FIG. 2 is a schematic cross-sectional view taken along the line II-II of the optical semiconductor device illustrated in FIG. 1.

FIG. 3 is a schematic cross-sectional view taken along the line III-III of the optical semiconductor device illustrated in FIG. 1.

FIG. 4 is a schematic cross-sectional view taken along the line IV-IV of the optical semiconductor device illustrated in FIG. 1.

FIG. 5 is a schematic view for illustrating a connection relationship between the optical semiconductor device according to the first example implementation and a differential transmission line.

FIG. 6 is a top view of an optical semiconductor device according to Modification Example 1 of the first example implementation and a schematic view for illustrating a connection relationship between the optical semiconductor device and the differential transmission line.

FIG. 7 is a top view of an optical semiconductor device according to Modification Example 2 of the first example implementation and a schematic view for illustrating a connection relationship between the optical semiconductor device and the differential transmission line.

FIG. 8 is a top view of an optical semiconductor device according to Modification Example 3 of the first example implementation and a schematic view for illustrating a connection relationship between the optical semiconductor device and the differential transmission line.

FIG. 9 is a schematic cross-sectional view taken along the line IX-IX of the optical semiconductor device illustrated in FIG. 8.

FIG. 10 is a top view of an optical semiconductor device according to Modification Example 4 of the first example implementation and a schematic view for illustrating a connection relationship between the optical semiconductor device and the differential transmission line.

FIG. 11 is a top view of an optical semiconductor device according to a second example implementation of the present invention.

FIG. 12 is a schematic cross-sectional view taken along the line XII-XII of the optical semiconductor device illustrated in FIG. 11.

FIG. 13 is a schematic cross-sectional view taken along the line XIII-XIII of the optical semiconductor device illustrated in FIG. 11.

FIG. 14 is a top view of a state in which an optical semiconductor device according to a third example implementation of the present invention is junction-down mounted to a submount.

FIG. 15 is a top view of an optical semiconductor device according to Modification Example 1 of the third example implementation.

FIG. 16 is a schematic cross-sectional view taken along the line XVI-XVI of the optical semiconductor device illustrated in FIG. 15.

FIG. 17 is a top view of a state in which the optical semiconductor device according to Modification Example 1 of the third example implementation is junction-down mounted to the submount.

FIG. 18 is a top view of an optical semiconductor device according to Modification Example 2 of the third example implementation.

FIG. 19 is a top view of an optical semiconductor device according to a fourth example implementation of the present invention.

FIG. 20 is a schematic cross-sectional view taken along the line XX-XX of the optical semiconductor device illustrated in FIG. 19.

FIG. 21 is a top view of an optical semiconductor device according to a fifth example implementation of the present invention.

FIG. 22 is a schematic cross-sectional view taken along the line XXII-XXII of the optical semiconductor device illustrated in FIG. 21.

FIG. 23 is a schematic cross-sectional view taken along the line XXIII-XXIII of the optical semiconductor device illustrated in FIG. 21.

FIG. 24 is a top view of an optical semiconductor device according to a sixth example implementation of the present invention.

FIG. 25 is a schematic cross-sectional view taken along the line XXV-XXV of the optical semiconductor device illustrated in FIG. 24.

FIG. 26 is a schematic cross-sectional view taken along the line XXVI-XXVI of the optical semiconductor device illustrated in FIG. 24.

FIG. 27 is a schematic cross-sectional view taken along the line XXVII-XXVII of the optical semiconductor device illustrated in FIG. 24.

FIG. 28 is a top view of an optical semiconductor device according to a seventh example implementation of the present invention.

FIG. 29 is a schematic cross-sectional view taken along the line XXIX-XXIX of the optical semiconductor device illustrated in FIG. 28.

FIG. 30 is a schematic cross-sectional view taken along the line XXX-XXX of the optical semiconductor device illustrated in FIG. 28.

### DETAILED DESCRIPTION

The following detailed description of example implementations refers to the accompanying drawings. The same reference numbers in different drawings may identify the same or similar elements.

A specific and detailed description is given below related to example implementations of the present invention with reference to the drawings. Members denoted by the same reference symbol throughout the drawings may have the same or an equivalent function, and a repetitive description on the members may be omitted. Note that sizes of graphics may be not always to scale.

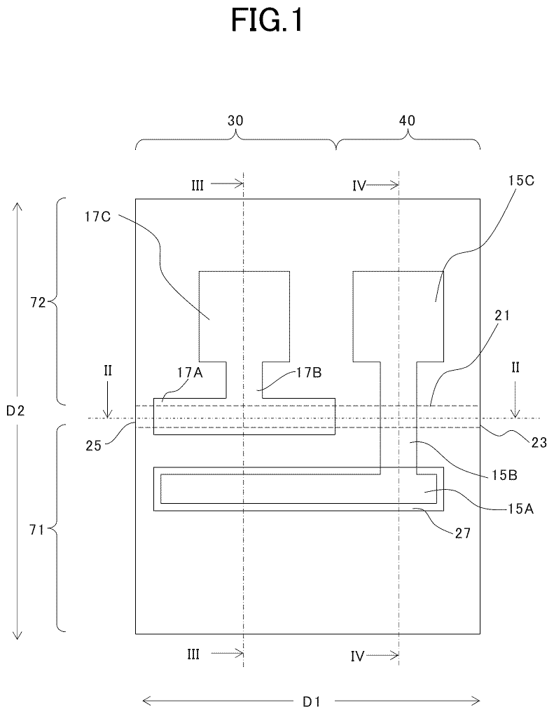

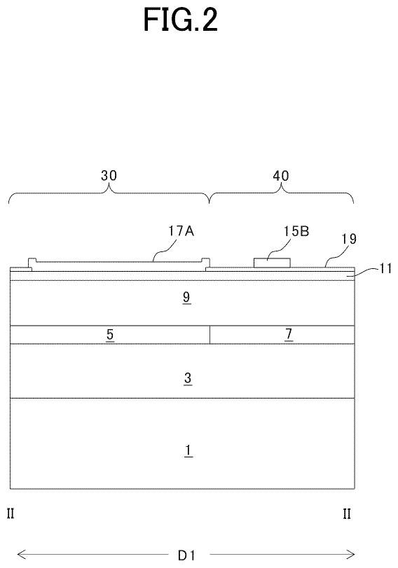

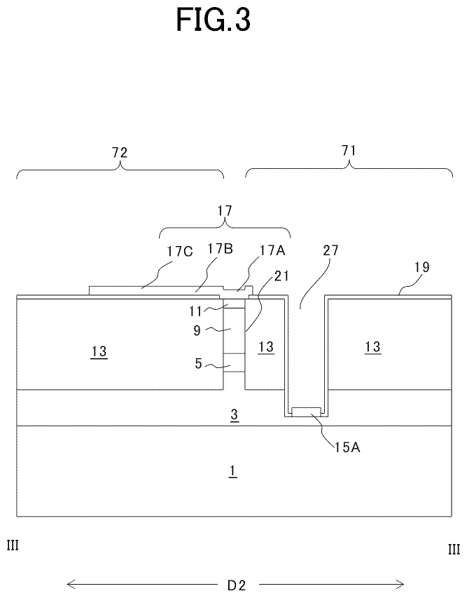

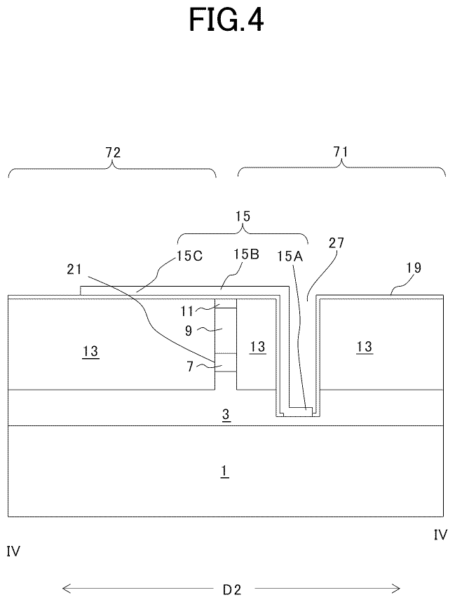

FIG. 1 is a top view of an optical semiconductor device according to a first example implementation of the present invention. FIG. 2 is a cross-sectional view for schematically illustrating a cross section taken along the line II-II of FIG. 1. FIG. 3 is a cross-sectional view for schematically illustrating a cross section taken along the line III-III of FIG. 1. FIG. 4 is a cross-sectional view for schematically illustrating a cross section taken along the line IV-IV of FIG. 1.

In the optical semiconductor device, a modulator unit 30 and a waveguide unit 40 may be integrated on a substrate 1 integrally. Light input from a facet (first facet 23) on the waveguide unit 40 side may be input to the modulator unit 30 via the waveguide unit 40. The modulator unit 30 converts the input light into a high-frequency optical signal to output the high-frequency optical signal from a facet (second facet 25) on the modulator unit 30 side. The modulator unit 30 may be an electro-absorption modulator. Each of the first facet 23 and the second facet 25 may have a protective film (not shown), for example, a low reflection film formed thereon. The modulator unit 30 and the waveguide unit 40 may be optically connected to each other by butt joint connection.

The modulator unit 30 may include, on the substrate 1, a first conductivity type semiconductor layer 3, an optical functional layer 5, a second conductivity type semiconductor layer 9, and a second conductivity type contact layer 11. Here, the substrate 1 may be an insulating (semi-insulating) semiconductor substrate. In this case, the first conductivity type semiconductor layer 3 may be an n-type semiconductor layer, and functions as a cladding layer and a layer for contact to a first electrode 15 to be described herein. The first conductivity type semiconductor layer 3 may include a plurality of layers. For example, the first conductivity type semiconductor layer 3 may include a first conductivity type contact layer. The optical functional layer 5 may include at least multiple quantum wells. In this case, the optical functional layer 5 functions as an absorption layer for absorbing light in accordance with the applied voltage. In this case, the second conductivity type semiconductor layer 9 may be a p-type semiconductor layer, and functions as a cladding layer. The second conductivity type semiconductor layer 9 may include a plurality of layers. The second conductivity type contact layer 11 may be a semiconductor layer connected to a second electrode 17 to be described herein. The conductivity of the second conductivity type contact layer 11 may be higher than the conductivity of the second conductivity type semiconductor layer 9, and the second conductivity type contact layer 11 may be arranged in order to reduce a contact resistance between the second electrode 17 and the semiconductor layer. The second conductivity type contact layer 11 is not required to be arranged. Further, another layer may be included between the first conductivity type semiconductor layer 3 and the optical functional layer 5 and/or between the second conductivity type semiconductor layer 9 and the optical functional layer 5. For example, an optical confinement layer may be arranged. The modulator unit 30 may be an active region for absorbing light in accordance with electric signals input to the first electrode 15 and the second electrode 17.

The waveguide unit 40 may include the first conductivity type semiconductor layer 3, a waveguide layer 7, the second conductivity type semiconductor layer 9, and the second conductivity type contact layer 11, which may be arranged on the substrate 1. The first conductivity type semiconductor layer 3, the second conductivity type semiconductor layer 9, and the second conductivity type contact layer 11 may be continuously formed in the same layers as the modulator unit 30, but may be formed separately therefrom. Further, the second conductivity type contact layer 11 is not required to be arranged. The waveguide layer 7 may include multiple quantum wells or may be a bulk semiconductor layer. In this case, the waveguide layer 7 may be a bulk semiconductor layer having a refractive index higher than that of the first conductivity type semiconductor layer 3 or the second conductivity type semiconductor layer 9. Another layer may be included between the first conductivity type semiconductor layer 3 and the waveguide layer 7 and/or between the second conductivity type semiconductor layer 9 and the waveguide layer 7. For example, an optical confinement layer may be arranged. The waveguide unit 40 may be a passive region to which no electric signal may be input. A boundary between the modulator unit 30 and the waveguide unit 40 may be defined by a butt joint interface between the optical functional layer 5 and the waveguide layer 7.

As illustrated in FIG. 3 and FIG. 4, the optical semiconductor device may include a mesa structure 21. The mesa structure 21 may include a part of the first conductivity type semiconductor layer 3, the optical functional layer 5 or the waveguide layer 7, the second conductivity type semiconductor layer 9, and the second conductivity type contact layer 11. The mesa structure 21 may extend in a first direction D1. In a second direction D2 orthogonal to the first direction D1, a buried layer 13 may be arranged on both side surfaces of the mesa structure 21. The buried layer 13 may be a semiconductor layer. Here, the buried layer 13 may be a semi-insulating semiconductor layer. The buried layer 13 may have a multilayer structure including a p-type semiconductor layer and an n-type semiconductor layer. The mesa structure 21 may be formed so as to extend from the first facet 23 to the second facet 25. In FIG. 1, an interface between an upper surface of the mesa structure 21 and the buried layer 13 is indicated by broken lines. On an upper surface of the buried layer 13, an insulating film 19 may be arranged except for a part of the upper surface. A first pad electrode 15C and a second pad electrode 17C which are to be described herein may be arranged on the buried layer 13. Here, with respect to the mesa structure 21 serving as a boundary, in the second direction D2, a side on which the second pad electrode 17C to be described herein is arranged may be referred to as “second region 72,” and a region on the opposite side may be referred to as “first region 71.” A region in which the mesa structure is provided is not included in the first region 71 and the second region 72.

The optical semiconductor device may include a trench portion 27. The trench portion 27 may be a dug portion extending from the surface of the buried layer 13 to reach the first conductivity type semiconductor layer 3. The trench portion 27 does not reach the first facet 23 and the second facet 25. The insulating film 19 may be arranged on a part of a bottom portion of the trench portion 27 and a side surface of the trench portion 27. In the bottom portion of the trench portion 27, the first conductivity type semiconductor layer 3 may be exposed. The first conductivity type semiconductor layer 3 and the first electrode 15 may be electrically/physically connected to each other in this exposed region. The trench portion 27 may be arranged across a region from the modulator unit 30 to the waveguide unit 40. The trench portion 27 may be formed in the first region 71. The side surface of the trench portion 27 may be illustrated as a surface perpendicular to the substrate 1, but the present invention is not limited thereto. For example, the side surface may be inclined with respect to the bottom portion of the trench portion 27 so that an upper side of the trench portion 27 becomes wider.

The optical semiconductor device may include the first electrode 15. The first electrode 15 may include a first connection electrode 15A connected to the first conductivity type semiconductor layer 3 at the bottom portion of the trench portion 27. When a first conductivity type contact layer is arranged, the first connection electrode 15A may be connected to the first conductivity type contact layer. In other words, the first connection electrode 15A represents a region of the first electrode 15 physically connected to the first conductivity type semiconductor layer (first conductivity type semiconductor layer 3 or first conductivity type contact layer) electrically connected to the optical functional layer 5. The first electrode 15 may include the first pad electrode 15C arranged on the upper surface of the buried layer 13. In addition, the first electrode 15 may include a first bridge electrode 15B connecting the first connection electrode 15A and the first pad electrode 15C to each other. Those three electrodes may be integrally formed. The first bridge electrode 15B and the first pad electrode 15C may be arranged in the waveguide unit 40 in plan view. A part of the first pad electrode 15C may be arranged in the modulator unit 30. In the width in the first direction D1, the first pad electrode 15C may be longer than the first bridge electrode 15B. The first pad electrode 15C may be connected to a wire or wiring to allow differential signals to be input to the optical semiconductor device. Accordingly, the first pad electrode 15C requires a certain area. In other words, the first pad electrode 15C represents a region of the first electrode 15 to which the wire is to be connected. In this case, the first pad electrode 15C may have a rectangular shape, but the present invention is not limited thereto. The first pad electrode 15C may may have any one of a circular shape, an elliptical shape, a rounded rectangular shape, or a polygonal shape. When the width in the first direction DI described above is defined, the width may be defined at the longest portion. An electric signal of one of a pair of differential signals may be input and/or output to and/or from the first pad electrode 15C. The first bridge electrode 15B may be desired to be as small as possible because the first bridge electrode 15B becomes a cause of occurrence of a parasitic capacitance. Accordingly, the first bridge electrode 15B may have the thinnest shape in the first direction D1. The first pad electrode 15C may be arranged in the second region 72. The first bridge electrode 15B may be arranged across a region from the first region 71 to the second region 72.

The optical semiconductor device may include the second electrode 17. The second electrode 17 may include a second connection electrode 17A connected to the second conductivity type contact layer 11 on the upper surface of the mesa structure 21. When no second conductivity type contact layer 11 may be arranged, the second connection electrode 17A may be connected to the second conductivity type semiconductor layer 9. In other words, the second connection electrode 17A represents a region of the second electrode 17 physically connected to the second conductivity type semiconductor layer (second conductivity type semiconductor layer 9 or second conductivity type contact layer 11) electrically connected to the optical functional layer 5. The second electrode 17 may include a second pad electrode 17C arranged on the upper surface of the buried layer 13. In addition, the second electrode 17 may include a second bridge electrode 17B connecting the second connection electrode 17A and the second pad electrode 17C to each other. Those three electrodes may be integrally formed. As illustrated in FIG. 2, a connection region between the second connection electrode 17A and the second conductivity type contact layer 11 does not extend across the entire optical functional layer 5 in the first direction D1, but the present invention is not limited thereto. The connection region may extend across the entire optical functional layer 5. The second bridge electrode 17B and the second pad electrode 17C may be arranged in the modulator unit 30 in plan view. In the width in the first direction D1, the second pad electrode 17C may be longer than the second bridge electrode 17B. The second pad electrode 17C may be connected to a wire or wiring to allow differential signals to be input to the optical semiconductor device. Accordingly, the second pad electrode 17C requires a particular area. In other words, the second pad electrode 17C represents a region of the second electrode 17 to which the wire may be to be connected. In this case, the second pad electrode 17C may have a rectangular shape, but the present invention is not limited thereto. The second pad electrode 17C may may have any one of a circular shape, an elliptical shape, a rounded rectangular shape, or a polygonal shape. When the width in the first direction D1 described above may be defined, the width may be defined at the longest portion. Further, the first pad electrode 15C and the second pad electrode 17C may be desired to may have the same surface area, but the present invention is not limited thereto. An electric signal of one of a pair of differential signals is to be input and/or output to and/or from the second pad electrode 17C. The second bridge electrode 17B may be desired to be as small as possible because the second bridge electrode 17B becomes a cause of occurrence of a parasitic capacitance. Accordingly, the second bridge electrode 17B may have a thinnest shape in the first direction D1. In the second direction D2, the second bridge electrode 17B and the second pad electrode 17C may be arranged in the second region 72. The first electrode 15 and the second electrode 17 may be each a metal layer, and may have the same material and layer structure or different materials and layer structures. As described above, the first pad electrode 15C and the second pad electrode 17C may be arranged with an offset in positions in a traveling direction of an optical path of the waveguide unit 40. The phrase “arranged with an offset” represents that, in the traveling direction of the optical path (that is, the first direction D1), a position of the first pad electrode 15C to which the wire is connected and a position of the second pad electrode 17C to which the wire is connected may be different from each other. For example, the first pad electrode 15C and the second pad electrode 17C may be arranged with an offset when centers of the first pad electrode 15C and the second pad electrode 17C in the first direction DI are shifted from each other.

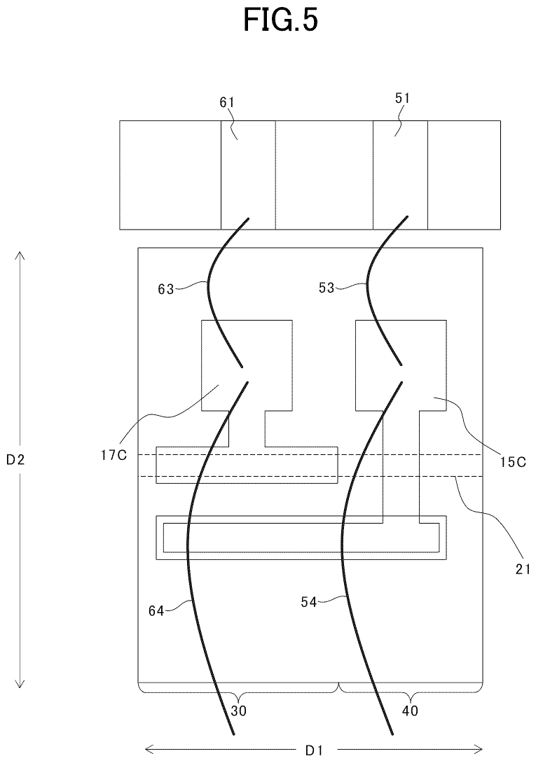

FIG. 5 is a schematic view obtained when wire connection is achieved between the differential transmission line and the optical semiconductor device. The differential transmission line may include a first transmission line 51 to be connected to the first pad electrode 15C, and a second transmission line 61 to be connected to the second pad electrode 17C. In general, the differential transmission line may include a pair of transmission lines through which a positive phase signal and a negative phase signal may be transmitted, respectively, and the pair of transmission lines may be wired substantially parallel to each other. The pair of transmission lines may be wired close to each other, and can thus transmit electric signals with excellent noise immunity. The first example implementation assumes a case in which the pair of transmission lines (first transmission line 51 and second transmission line 61) are arranged up to positions right before the optical semiconductor device. The first transmission line 51 and the first pad electrode 15C may be connected to each other by a first wire 53. The second transmission line 61 and the second pad electrode 17C may be connected to each other by a second wire 63. Further, the first pad electrode 15C may be connected to a matching resistor (not shown) via a third wire 54. Similarly, the second pad electrode 17C may be connected to a matching resistor (not shown) via a fourth wire 64. Here, the matching resistor may be arranged in order to improve the performance of impedance matching with an external drive system. Further, the first wire 53 and the third wire 54 may be one continuous wire. Similarly, the second wire 63 and the fourth wire 64 may be one continuous wire.

In the first example implementation, a distance between the first transmission line 51 and the first pad electrode 15C may be substantially equal to a distance between the second transmission line 61 and the second pad electrode 17C. Accordingly, the lengths of the first wire 53 and the second wire 63 may be substantially equal to each other. Actually, a wire may be formed into a loop shape, and hence it may be difficult to make the lengths of the two wires completely the same. However, the distance between the transmission line and the pad electrode may be substantially the same, and hence a difference between the lengths of the two wires may be reduced. Moreover, the two wires may be substantially parallel to each other, and a strong noise immunity state may be kept until right before an electric signal is input to the optical semiconductor device. Because the difference between the lengths of the two wires may be small and the two wires may be arranged in parallel to each other, the optical semiconductor device can bring the impedance characteristics on the positive phase signal side and the negative phase signal side close to each other during the differential drive, and can suppress the deterioration of the characteristics due to impedance mismatch. Further, the lengths of the two wires of the third wire 54 and the fourth wire 64 may be adjusted to be substantially equal to each other. The length of the wire connected to the matching resistor also affects the impedance characteristics, and hence it may be preferred that the wire lengths be adjusted to be the same. In this case, the positive phase signal may be input to the first transmission line 51, and the negative phase signal may be input to the second transmission line 61. In this case, the positive phase signal and the negative phase signal merely mean signals that may have phases reversed by 180 degrees from each other, and do not mean a positive voltage or a negative voltage.

In the optical semiconductor device according to the first example implementation, the waveguide unit 40 may be intentionally added to the modulator, and one pad electrode (in this case, the first pad electrode 15C) may be arranged in the waveguide unit 40. Thus, the first pad electrode 15C and the second pad electrode 17C may be arranged with an offset in positions in the traveling direction of the optical path of the waveguide unit. In this manner, the lengths of the two wires may be brought close to each other. The cost of the optical semiconductor device may be greatly affected by the device size. Accordingly, it may not be preferred to arrange the waveguide unit 40 in the viewpoint of cost. For example, when the two pad electrodes are arranged to be line-symmetric with respect to the mesa structure and no waveguide unit 40 is arranged, the size may be reduced as a whole. However, in the first example implementation, in order to bring the lengths of the two wires as close as possible to each other, the waveguide unit 40 may be arranged, and the first pad electrode 15C may be arranged in the region of the waveguide unit 40 so that this object may be achieved. Further, as the first bridge electrode 15B becomes longer, a parasitic capacitance may be generated and the characteristics of the optical semiconductor device may be degraded, and hence it may be desired that the length of the first bridge electrode 15B in the second direction D2 be as short as possible. In the first example implementation, the trench portion 27 may be arranged up to a region reaching the waveguide unit 40 so that the first connection electrode 15A and the first pad electrode 15C may be connected to each other at the shortest distance. Accordingly, the first bridge electrode 15B may be prevented from becoming long. With this structure, the parasitic capacitance caused by the first bridge electrode 15B may be reduced, and an optical semiconductor device excellent in high-speed operation may be achieved. In the first example implementation, description has been given of an example in which light is input from the first facet 23 on the waveguide unit 40 side and modulated light is output from the second facet 25 on the modulator unit 30 side, but the present invention is not limited thereto. The input and the output may be reversed. That is, continuous light may be input from the second facet 25, and modulated light may be output from the first facet 23.

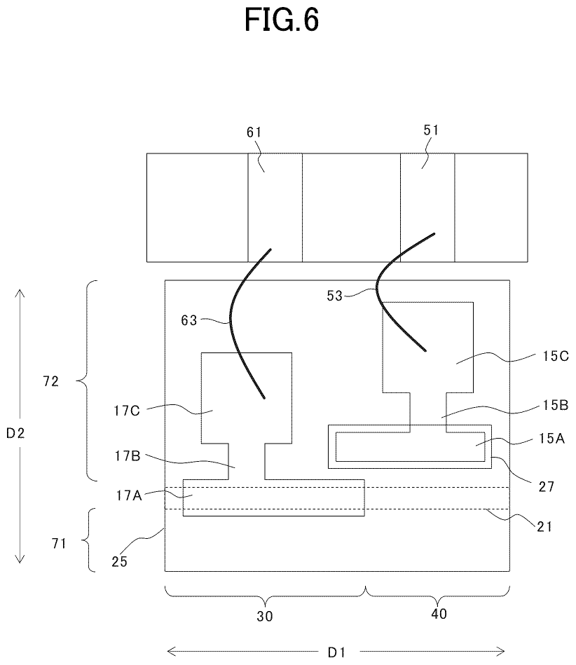

FIG. 6 is a top view of an optical semiconductor device according to Modification Example 1 of the first example implementation and a schematic view for illustrating a connection relationship between the optical semiconductor device and the differential transmission line. The difference from the first example implementation resides in the position and the size of the trench portion 27, and the shapes of the first electrode 15 and the second electrode 17. Further, the width of the optical semiconductor device in the second direction D2 may be narrower than that of the first example implementation. In the following modification examples and example implementations, for the sake of easy description, the illustration of the third wire 54 and the fourth wire 64 is omitted. Similarly to the first example implementation, the third wire 54 and the fourth wire 64 may be arranged.

In Modification Example 1, the trench portion 27 may be arranged so that its longitudinal direction extends along the first direction D1 and its position in the second direction D2 may be arranged in a region overlapping the second bridge electrode 17B and the second pad electrode 17C. In other words, in the second direction D2, the trench portion 27 may be arranged in the second region 72. As illustrated in FIG. 6, the entire region of the first electrode 15 may be arranged in the second region 72. Similarly to the first example implementation, the trench portion 27 may be arranged in a region across both of the modulator unit 30 and the waveguide unit 40. However, in the first direction D1, the trench portion 27 may be shorter than that in the first example implementation. The trench portion 27 may be arranged in the second region 72, and hence the first bridge electrode 15B can become shorter (reduced in area) as compared to that in the first example implementation. Accordingly, the parasitic capacitance caused by the first bridge electrode 15B may be reduced. Moreover, no trench portion 27 may be arranged in the first region 71, and hence the first region 71 may be reduced. In other words, the width of the optical semiconductor device in the second direction D2 may be reduced. With this structure, the increase in size of the optical semiconductor device due to the addition of the waveguide unit 40 may be suppressed, and an optical semiconductor device also excellent in cost may be achieved.

Further, the second bridge electrode 17B and the second pad electrode 17C may be arranged closer to the second facet 25 as compared to the first example implementation. In the first example implementation, the centers of the second bridge electrode 17B and the second pad electrode 17C in the first direction DI match the center of the second connection electrode 17A. In Modification Example 1, the centers of the second bridge electrode 17B and the second pad electrode 17C in the first direction D1 may be shifted from the center of the second connection electrode 17A to the second facet 25 side. This shift may be provided to prevent the trench portion 27 from interfering with the second bridge electrode 17B and the second pad electrode 17C, and is not an essential requirement.

In the first example implementation, center positions of the first pad electrode 15C and the second pad electrode 17C in the second direction D2 match each other, but the center positions do not match each other in Modification Example 1. The first pad electrode 15C may be arranged closer to the differential transmission line, and hence the lengths of the first wire 53 and the second wire 63 may be slightly different from each other. However, the wire lengths may be brought close to each other by adjusting the height of the loop of the wire, for example. Accordingly, the influence on the impedance characteristics may not be so large. The second pad electrode 17C may be shifted to the differential transmission line side so that the center positions of the first pad electrode 15C and the second pad electrode 17C in the second direction D2 match each other. In this case, the second bridge electrode 17B becomes long, and hence there may be a disadvantage in that a capacitance caused by the second bridge electrode 17B is increased. However, the effect of bringing the lengths of the first wire 53 and the second wire 63 close to each other may be obtained.

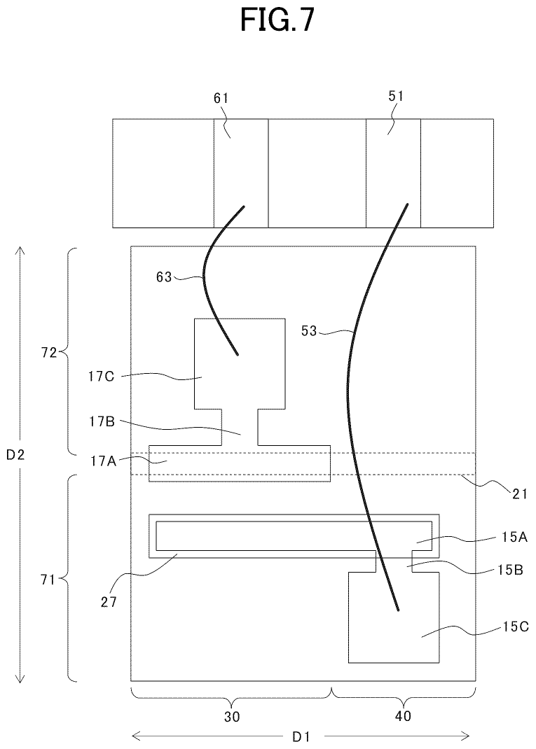

FIG. 7 is a top view of an optical semiconductor device according to Modification Example 2 of the first example implementation and a schematic view for illustrating a connection relationship between the optical semiconductor device and the differential transmission line. The difference from the first example implementation resides in the arrangement of the first bridge electrode 15B and the first pad electrode 15C.

In Modification Example 2, all of the three parts of the first electrode 15 may be arranged in the first region 71. Accordingly, the first bridge electrode 15B can become short. In regard to this point, the optical semiconductor device according to Modification Example 2 may be excellent at high-speed operation. Meanwhile, the first wire 53 becomes longer than the second wire 63. Accordingly, from the viewpoint of impedance, Modification Example 2 may be slightly deteriorated as compared to the first example implementation. However, the two wires may be arranged substantially parallel to each other, and hence the optical semiconductor device according to Modification Example 2 may be excellent at noise immunity.

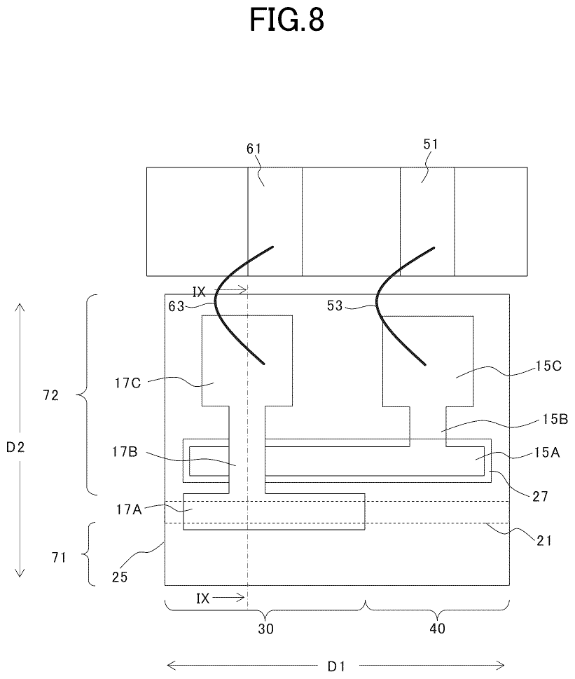

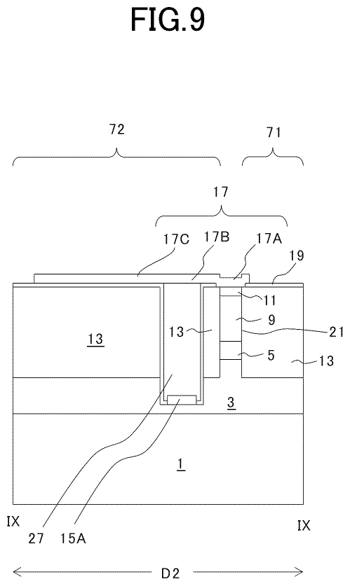

FIG. 8 is a top view of an optical semiconductor device according to Modification Example 3 of the first example implementation and a schematic view for illustrating a connection relationship between the optical semiconductor device and the differential transmission line. FIG. 9 is a cross-sectional view schematically illustrating a cross section taken along the line IX-IX of FIG. 8. Modification Example 3 is different from the first example implementation and other modification examples particularly in the arrangement of the trench portion 27 and the structure of the second bridge electrode 17B.

The trench portion 27 may be arranged in a region across the modulator unit 30 and the waveguide unit 40 in the second region 72. Moreover, similarly to the first example implementation, most part of the first connection electrode 15A may be arranged in a region in which a position thereof in the first direction DI is the same as that of the second connection electrode 17A. Specifically, an end portion of the first connection electrode 15A on the second facet 25 side may be arranged on the second facet 25 side with respect to the second pad electrode 17C in the first direction D1. The second bridge electrode 17B may be arranged to straddle the trench portion 27 above the trench portion 27. Such structure may be also referred to as an “air bridge structure.” In Modification Example 3, the centers of the first pad electrode 15C and the second pad electrode 17C in the second direction D2 match each other. In other words, the distance between the first transmission line 51 and the first pad electrode 15C may be substantially equal to the distance between the second transmission line 61 and the second pad electrode 17C.

Description has been given above of some modes in which the first pad electrode 15C is arranged in the waveguide unit 40 in plan view. The effects of the present invention may be obtained when the trench portion 27 and the first connection electrode 15A are arranged a region across the modulator unit 30 and the waveguide unit 40, at least a part of the first pad electrode 15C is arranged in the waveguide unit 40, and the first pad electrode 15C and the second pad electrode 17C are arranged with an offset in positions in the traveling direction of the optical path of the waveguide unit.

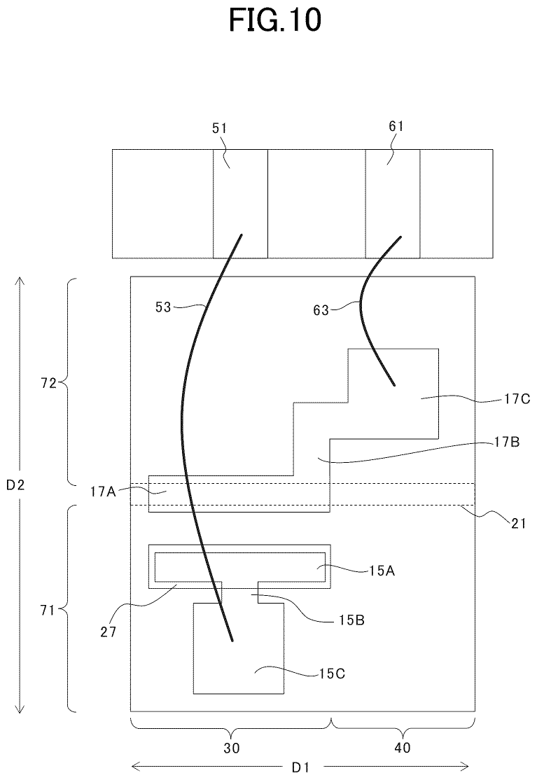

FIG. 10 is a top view of an optical semiconductor device according to Modification Example 4 of the first example implementation and a schematic view for illustrating a connection relationship between the optical semiconductor device and the differential transmission line. In Modification Example 4, the second pad electrode 17C may be arranged in the waveguide unit 40 in plan view. In addition, all of the three parts of the first electrode 15 may be arranged in the modulator unit 30 in plan view.

The second bridge electrode 17B connects the second connection electrode 17A and the second pad electrode 17C to each other in an L-shape in plan view, but the shape is not limited thereto. The shape may be a straight line or a curved line. In Modification Example 4 as well, the first wire 53 and the second wire 63 may be arranged substantially parallel to each other while the first pad electrode 15C and the second pad electrode 17C may be prevented from overlapping each other in the second direction D2.

As described above, when any one of the first pad electrode 15C or the second pad electrode 17C is arranged in the waveguide unit 40 in plan view, and the first pad electrode 15C and the second pad electrode 17C are arranged with an offset in positions in the traveling direction of the optical path of the waveguide unit 40, the effects described above may be obtained. In the first example implementation and the modification examples thereof, description has been given of an example in which the whole first pad electrode 15C or the whole second pad electrode 17C is arranged in the waveguide unit 40, but the present invention is not limited thereto. For example, the first pad electrode 15C may be arranged in a region across the modulator unit 30 and the waveguide unit 40 in plan view.

In the first example implementation and the modification examples thereof, positions of distal ends of the first connection electrode 15A and the second connection electrode 17A on the second facet 25 side do not match each other, but the distal ends may match each other.

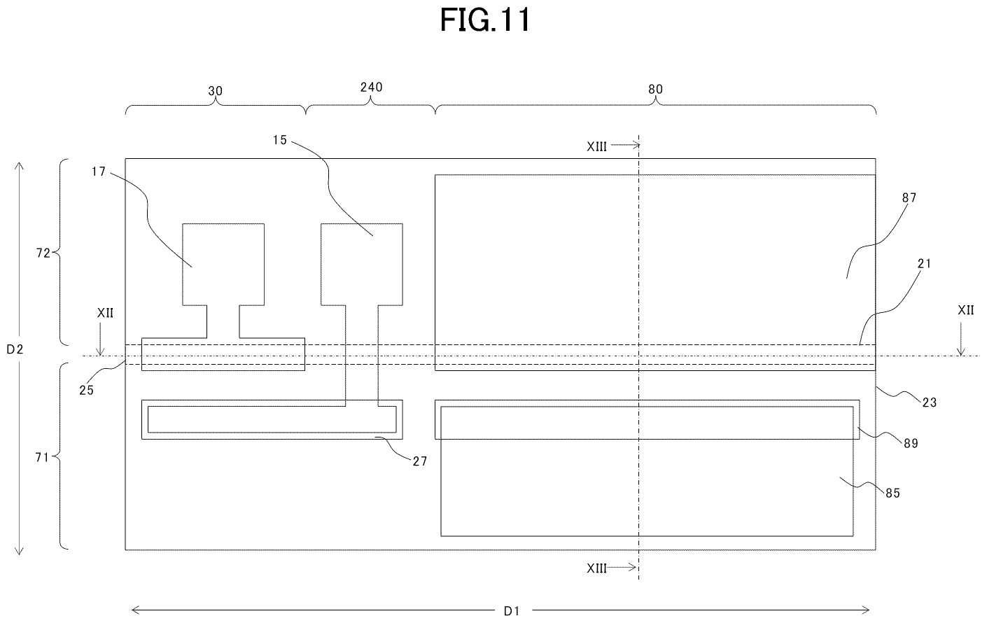

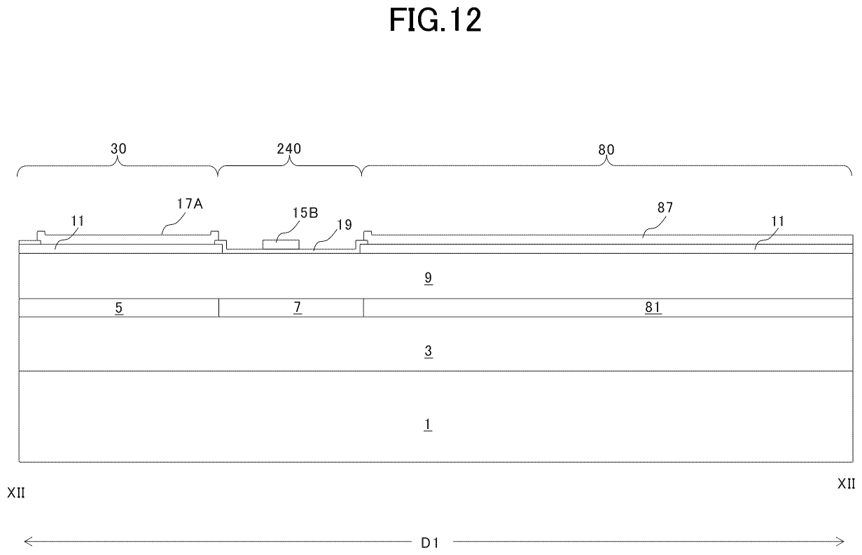

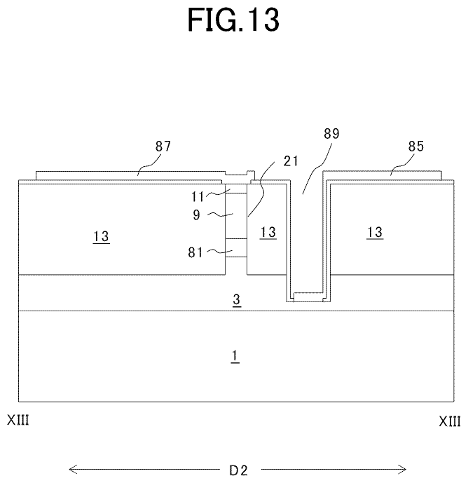

FIG. 11 is a top view of an optical semiconductor device according to a second example implementation of the present invention. FIG. 12 is a cross-sectional view for schematically illustrating a cross section taken along the line XII-XII of FIG. 11. FIG. 13 is a cross-sectional view for schematically illustrating a cross section taken along the line XIII-XIII of FIG. 11.

In the optical semiconductor device, the modulator unit 30, a waveguide unit 240, and the semiconductor laser unit 80 may be integrated on the substrate 1 integrally. The semiconductor laser unit 80 outputs continuous light. The waveguide unit 240 transmits output light of the semiconductor laser unit 80 to the modulator unit 30. A first facet 23 may be also a facet of the semiconductor laser unit 80, and may have a high reflection film (not shown) formed thereon. The first facet 23 may may have a low reflection film formed thereon. The second facet 25 may have a low reflection film (not shown) formed thereon. The modulator unit 30 and the waveguide unit 240 may be optically connected to each other by butt joint connection, and the waveguide unit 240 and the semiconductor laser unit 80 may be also optically connected to each other by butt joint connection. Here, the modulator unit 30 may have the same structure as that of the first example implementation, but those structures may be different from each other.

The waveguide unit 240 may have substantially the same structure as that of the waveguide unit 40 in the first example implementation, but no second conductivity type contact layer 11 may be arranged on the upper surface of the mesa structure 21 of the waveguide unit 240. No second conductivity type contact layer 11 may be arranged in order to reduce electrical cross-talks between the modulator unit 30 and the semiconductor laser unit 80. The second conductivity type contact layer 11 may be arranged in the waveguide unit 240.

The semiconductor laser unit 80 may include, on the substrate 1, a first conductivity type semiconductor layer 3, an active layer 81, a second conductivity type semiconductor layer 9, and a second conductivity type contact layer 11. The first conductivity type semiconductor layer 3 and the second conductivity type semiconductor layer 9 may be formed in the same layers as the modulator unit 30, but may be formed separately therefrom. The active layer 81 may include at least multiple quantum wells. Continuous light may be generated when an electric current is injected to the active layer 81. Another layer may be included between the first conductivity type semiconductor layer 3 and the active layer 81, and/or between the second conductivity type semiconductor layer 9 and the active layer 81. For example, an optical confinement layer may be arranged. Further, a grating layer may be included. In this case, the semiconductor laser unit 80 may be a DFB laser for outputting light of a 1.3 micrometers (μm)-band. The oscillation wavelength may be in a 1.55-μm band, or may be in other wavelength bands. Further, the semiconductor laser unit 80 is not limited to the DFB laser, and may be a DBR laser. A boundary between the waveguide unit 240 and the semiconductor laser unit 80 may be defined by a butt joint interface between the waveguide layer 7 and the active layer 81.

As illustrated in FIG. 13, also the semiconductor laser unit 80 may include a part of the mesa structure 21, and the buried layer 13 may be arranged on both side surfaces of the mesa structure 21. The semiconductor laser unit 80 may include a laser trench portion 89. The laser trench portion 89 may be a dug portion extending from the surface of the buried layer 13 to reach the first conductivity type semiconductor layer 3. The laser trench portion 89 does not reach the waveguide unit 240. Further, the laser trench portion 89 does not reach the first facet 23. The laser trench portion 89 may be arranged in the first region 71.

The semiconductor laser unit 80 may include a first laser electrode 85 and a second laser electrode 87. The first laser electrode 85 may be arranged in the first region 71, and may be electrically and physically connected to the first conductivity type semiconductor layer 3 in a bottom surface of the laser trench portion 89. The second laser electrode 87 may be arranged from an upper surface of the mesa structure 21 to the second region 72. The second laser electrode 87 may be electrically and physically connected to the second conductivity type contact layer 11 at the upper surface of the mesa structure 21. The first laser electrode 85 and the second laser electrode 87 each may have a rectangular shape in plan view, but the present invention may be may not be limited thereto. Further, the laser trench portion 89 and the first laser electrode 85 may be arranged in the second region 72, and the second laser electrode 87 may be arranged on the upper surface of the mesa structure 21 and in the first region 71.

In some implementations, an optical semiconductor device may include a modulator and a semiconductor laser that are integrated in one substrate, and a high-frequency electric signal may be applied to the modulator. Further, a direct current (DC) may be injected (DC voltage may be applied) to the semiconductor laser. When the electric signal applied to the modulator is transmitted to the semiconductor laser, and thus the laser light is modulated, this may not be preferred in terms of optical characteristics. In the second example implementation, the waveguide unit 240 may be arranged between the modulator unit 30 and the semiconductor laser unit 80. The waveguide unit 240 allows a distance to be secured between the modulator unit 30 and the semiconductor laser unit 80, and thus electrical cross-talks may be reduced. Moreover, no second conductivity type contact layer 11 is arranged in the waveguide unit 240 in order to increase an electric resistance between the modulator unit 30 and the semiconductor laser unit 80.

The waveguide unit 240 not only suppresses the electrical cross-talks as described above, but also allows at least a part of the first pad electrode 15C or the second pad electrode 17C to be arranged therein as described in the first example implementation. Accordingly, also in the second example implementation, similarly to the first example implementation, the difference between the lengths of the two wires connected to the differential transmission line may be reduced.

In the second example implementation, the modulator unit and the waveguide unit may be replaced with those in the modification examples of the first example implementation. That is, Modification Example 1 to Modification Example 4 of the first example implementation may be applied to the second example implementation. Further, a part of the laser trench portion 89 may be arranged in the waveguide unit 240. However, it may not be preferred that the trench portion 27 and the laser trench portion 89 have the same position in the second direction D2.

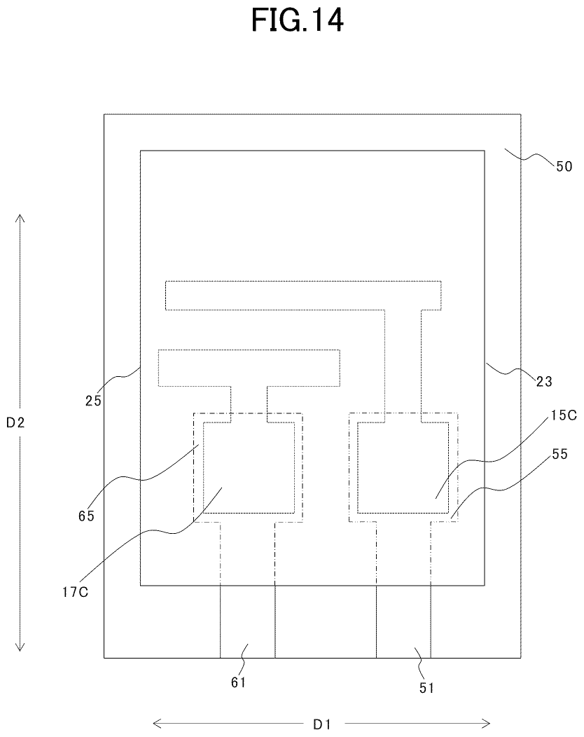

FIG. 14 is a top view for illustrating a state in which an optical semiconductor device according to a third example implementation of the present invention may be junction-down mounted to a submount.

A submount 50 may be a mounting substrate on which an optical semiconductor device is to be mounted, and may be formed from, for example, ceramics. FIG. 14 shows a state in which the optical functional layer 5 side (that is, the upper side of the drawing sheet of FIG. 3) of the optical semiconductor device may be mounted toward the submount 50. Here, the optical semiconductor device may be the same as the optical semiconductor device described in the first example implementation. The optical semiconductor device may be junction-down mounted, and hence the first electrode 15 and the second electrode 17 cannot be viewed in top view, but for the sake of description, the first electrode 15 and the second electrode 17 of the optical semiconductor device may be indicated by broken lines.

The submount 50 may have a pair of differential transmission lines (first transmission line 51 and second transmission line 61) formed thereon. The first transmission line 51 may include a first differential pad 55 to be connected to the first pad electrode 15C. The first differential pad 55 may be continuously formed integrally with the first transmission line 51. In this case, in plan view, in the first direction D1, the first differential pad 55 may be larger than the first pad electrode 15C. Similarly, the second transmission line 61 may include a second differential pad 65 to be connected to the second pad electrode 17C. The second differential pad 65 may be continuously formed integrally with the second transmission line 61. In this case, in plan view, in the first direction D1, the second differential pad 65 may be larger than the second pad electrode 17C. The sizes of the first differential pad 55 and the second differential pad 65 may be freely selected. For the sake of description, the first transmission line 51, the first differential pad 55, the second transmission line 61, and the second differential pad 65 in regions overlapping the optical semiconductor device may be indicated by long dashed double-short dashed lines. The first pad electrode 15C and the first differential pad 55 may be connected to each other by solder (not shown). Similarly, the second pad electrode 17C and the second differential pad 65 may be connected to each other by solder (not shown). The method for connection is not limited to solder, and a conductive adhesive may be used for connection. The pair of differential transmission lines may be connected to a matching resistor (not shown).

In the third example implementation, unlike the first example implementation, the differential transmission line and the optical semiconductor device may be connected to each other without using a wire. Accordingly, impedance mismatch due to a wire can be reduced. Moreover, the pair of transmission lines of the differential transmission line may be wired in parallel to each other up to positions right before connection to the optical semiconductor device, and hence characteristics of being excellent in noise immunity may be obtained. The reason therefor may be because two pad electrodes of the optical semiconductor device of the third example implementation may be arranged at positions different from each other in the first direction D1, owing to the first pad electrode 15C being arranged in the waveguide unit 40. For example, in the case of a modulator-integrated semiconductor laser, the two electrodes of the modulator may be arranged at the same position in the second direction D2, and hence connection to the differential transmission line as described in the third example implementation cannot be established. The connection to the electrodes of the modulator cannot be established unless the two transmission lines forming the differential transmission line are arranged apart from each other and shaped so as to avoid interference therebetween. Accordingly, the advantage of the differential transmission line may be lost right before the modulator.

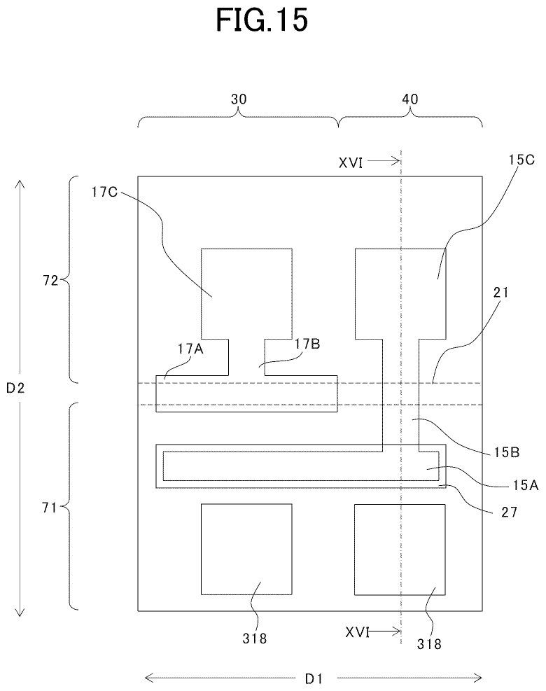

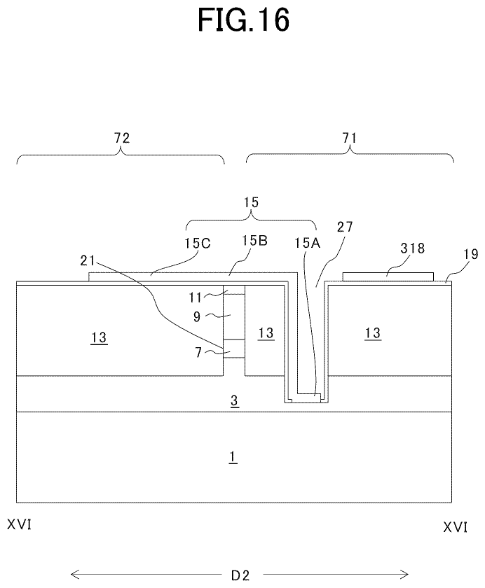

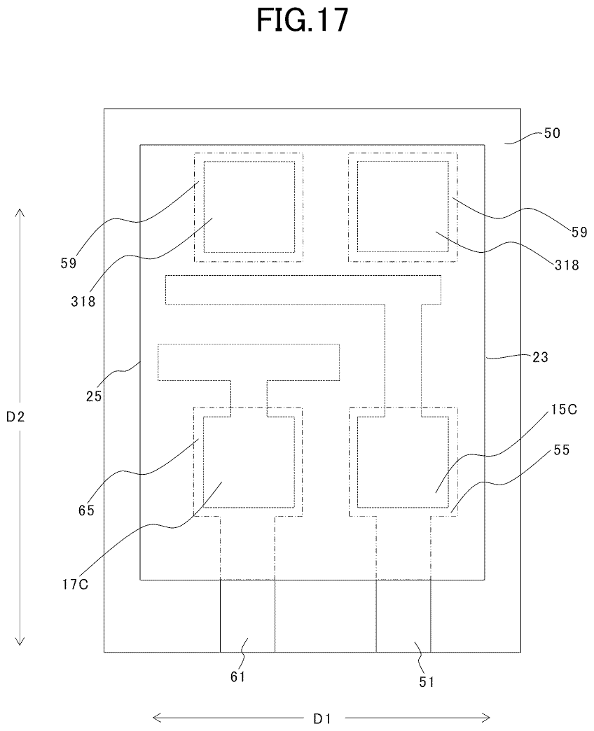

FIG. 15 is a top view of an optical semiconductor device according to Modification Example 1 of the third example implementation. FIG. 16 is a cross-sectional view schematically illustrating a cross section taken along the line XVI-XVI of FIG. 15. FIG. 17 is a top view for illustrating a state in which the optical semiconductor device of Modification Example 1 may be junction-down mounted to the submount 50.

The optical semiconductor device according to Modification Example 1 may be different from the optical semiconductor device according to the third example implementation only in presence or absence of a dummy electrode 318. Two dummy electrodes 318 may be arranged in the first region 71. In other words, the dummy electrodes 318 may be arranged in a region (first region 71) on a side opposite to a region (second region 72) in which the first pad electrode 15C and the second pad electrode 17C may be arranged with respect to the mesa structure 21. The dummy electrodes 318 each may have a size substantially equal to that of the first pad electrode 15C in plan view. However, the sizes may be not required to completely match each other. The insulating film 19 may be arranged between each of the dummy electrodes 318 and a semiconductor layer (in this case, the buried layer 13). In other words, each of the dummy electrodes 318 is not may not be electrically connected to the optical functional layer 5.

The arrangement of the dummy electrodes 318 provides two effects. First, the balance of the stress caused by the electrodes on the surface of the optical semiconductor device may be adjusted. The first electrode 15 and the second electrode 17 may each be a metal layer, and hence, in some case, the first electrode 15 and the second electrode 17 may have coefficients of thermal expansion larger than that of the semiconductor layer. Accordingly, those metal electrodes apply stress to the semiconductor layer. In the first example implementation, the first pad electrode 15C and the second pad electrode 17C, which may have relatively large areas, may be arranged only in the second region 72. Accordingly, the stress received from the expansion of the electrodes differs between the first region 71 and the second region 72. Such a difference in stress balance may affect the optical characteristics and the reliability. In Modification Example 1, the electrodes (dummy electrodes 318) may be also arranged in the first region 71, and hence the electrode stress on the surface may be balanced. The first electrode 15 and the dummy electrode 318 may be desired to be formed from the same material and may have the same thickness, but the present invention is not limited thereto.

The second effect resides in enhancement of an adhesive strength to the submount 50. As illustrated in FIG. 17, the submount 50 may have adhesion pads 59 provided at positions overlapping the dummy electrodes 318. The adhesion pads 59 may be electrically insulated from the differential transmission line. The adhesion pad 59 and the dummy electrode 318 may be caused to adhere to each other by solder or a conductive adhesive (not shown). As compared to the third example implementation, the number of portions of connection between the optical semiconductor device and the submount 50 may be increased, and hence the adhesive strength of the optical semiconductor device may be increased.

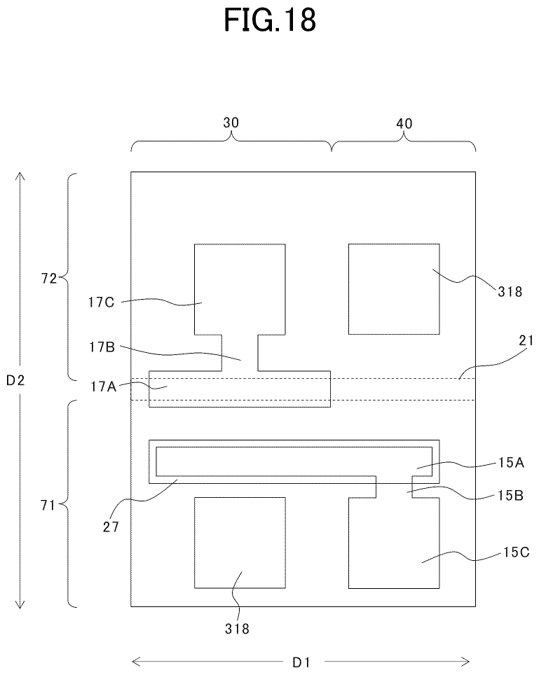

FIG. 18 is a top view of an optical semiconductor device according to Modification Example 2 of the third example implementation. The basic structure may be the same as that of Modification Example 2 of the first example implementation. Similarly to Modification Example 1 of the third example implementation, the dummy electrodes 318 may be arranged also in Modification Example 2. In Modification Example 2, in plan view, the two dummy electrodes, the first pad electrode 15C, and the second pad electrode 17C may be arranged at positions as four pips of a die. Also in Modification Example 2, the stress caused by the electrodes may be balanced. As described above, when the dummy electrode may be arranged in a region on a side opposite to the first pad electrode 15C or the second pad electrode 17C across the mesa structure, stress caused by the electrodes may be balanced. Moreover, at the time of junction-down mounting, the adhesive strength between the optical semiconductor device and the submount may be enhanced.

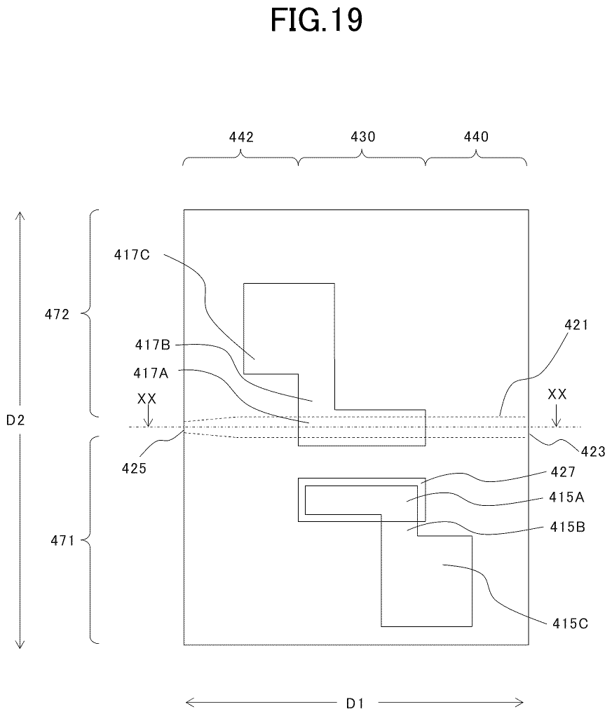

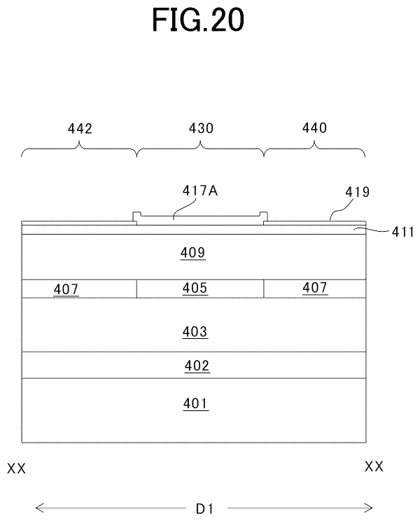

FIG. 19 is a top view of an optical semiconductor device according to a fourth example implementation of the present invention. FIG. 20 is a cross-sectional view for schematically illustrating a cross section taken along the line XX-XX of FIG. 19.

In the optical semiconductor device, a first waveguide unit 440, a modulator unit 430, and a second waveguide unit 442 may be arranged on a substrate 401 integrally. Light input from a facet side (first facet 423) of the first waveguide unit 440 may be input to the modulator unit 430 via the first waveguide unit 440. The modulator unit 430 converts the input light into a high-frequency optical signal to output the high-frequency optical signal to the second waveguide unit 442. The modulator unit 430 may be an electro-absorption modulator. The second waveguide unit 442 transmits the input optical signal to a second facet 425. Each of the first facet 423 and the second facet 425 may have a protective film (not shown), for example, a low reflection film formed thereon. The first waveguide unit 440 and the modulator unit 430 may be optically connected to each other by butt joint connection, and the modulator unit 430 and the second waveguide unit 442 may be optically connected to each other by butt joint connection.

The modulator unit 430 may include, on the substrate 401, an insulating semiconductor layer 402, a first conductivity type semiconductor layer 403, an optical functional layer 405, a second conductivity type semiconductor layer 409, and a second conductivity type contact layer 411. Here, the substrate 401 may be a conductive semiconductor substrate. For example, the substrate 401 may be a first conductivity type semiconductor substrate. The insulating semiconductor layer 402 may be an insulating/semi-insulating semiconductor layer having a resistance sufficiently larger than that of the conductive substrate 401. The insulating semiconductor layer 402 may be arranged for electrical insulation between the first conductivity type semiconductor layer 403 and the substrate 401. A configuration from the first conductivity type semiconductor layer 403 to the second conductivity type contact layer 411 may be similar to that of the modulator unit 30 in the first example implementation.

The first waveguide unit 440 may have a configuration similar to that of the waveguide unit 40 in the first example implementation except that the insulating semiconductor layer 402 may be arranged between the substrate 401 and the first conductivity type semiconductor layer 403. A boundary between the modulator unit 430 and the first waveguide unit 440 may be defined by a butt joint interface between the optical functional layer 405 and a waveguide layer 407.

The second waveguide unit 442 may have substantially the same configuration as that of the first waveguide unit 440. In this case, the waveguide layer 407 of the first waveguide unit 440 and the waveguide layer 407 of the second waveguide unit 442 may have the same layer configuration, but may may have different layer configurations.

Also in the fourth example implementation, the optical semiconductor device may include a mesa structure 421, and a buried layer may be arranged on side surfaces of the mesa structure 421. The mesa structure 421 extends from the first facet 423 to reach the second facet 425. In FIG. 19, an interface between an upper surface of the mesa structure 421 and the buried layer may be indicated by the broken line. Further, in the second waveguide unit 442, the mesa structure 421 may have a region in which a width in the second direction D2 may be gradually decreased toward the second facet 425 in plan view. The mesa structure 421 may may have a shape in which the width of the mesa structure in this region is gradually increased. This configuration may be provided to adjust the shape of the light output from the second facet 425. The mesa structure 421 may have the same width across the entire region (from the first facet 423 to the second facet 425). Moreover, at least a part of the second waveguide unit 442 may not be required to include the mesa structure 421. For example, a structure called a window structure that includes no mesa structure may be provided.

The modulator unit 430 may include a first electrode 415 connected to the first conductivity type semiconductor layer 403, and a second electrode 417 connected to the second conductivity type contact layer 411. Similarly to the first example implementation, each of the electrodes may be roughly divided into three parts.

The optical semiconductor device may include a trench portion 427 which may be a dug portion extending from the surface of the buried layer to reach the first conductivity type semiconductor layer 403. Here, the trench portion 427 may be arranged only in the region of the modulator unit 430. In other words, the trench portion 427 does not reach the first waveguide unit 440 and the second waveguide unit 442 in the first direction D1. Similarly, a first connection electrode 415A may be arranged only in the region of the modulator unit 430.

A part of a first pad electrode 415C may be arranged in the first waveguide unit 440. Further, in this case, the first pad electrode 415C may be arranged in a first region 471. A part of a second pad electrode 417C may be arranged in the second waveguide unit 442. Further, in this case, the second pad electrode 417C may be arranged in a second region 472.

Also in the fourth example implementation, the effects described in the first example implementation may be obtained, and an optical semiconductor device having excellent characteristics may be provided. Further, in order to adapt to high-speed operation, it may be effective to reduce the length of the optical functional layer 405 in the first direction D1. In a case in which the optical functional layer 405 is short, when the second pad electrode 417C is only arranged in the region of the modulator unit 430, a distance to the first pad electrode 415C may become short. As a result, there may be a fear that two wires come close to each other.

When the two wires are physically brought into contact with each other, as a matter of course, normal operation cannot be performed. In the fourth example implementation, the waveguide units may be arranged at both ends of the modulator unit 430 in order to increase the interval between the first pad electrode 415C and the second pad electrode 417C, and a part of the pad electrode may be arranged in each of those regions. The entire first pad electrode 415C may be arranged in the region of the first waveguide unit 440. Similarly, the entire second pad electrode 417C may be arranged in the region of the second waveguide unit 442. Further, the first pad electrode 415C may be arranged in the second waveguide unit 442, and the second pad electrode 417C may be arranged in the first waveguide unit 440.

The trench portion 427 may extend to a region reaching the first waveguide unit 440. Moreover, similarly to the first example implementation, the first pad electrode 415C may be arranged in the second region 472.

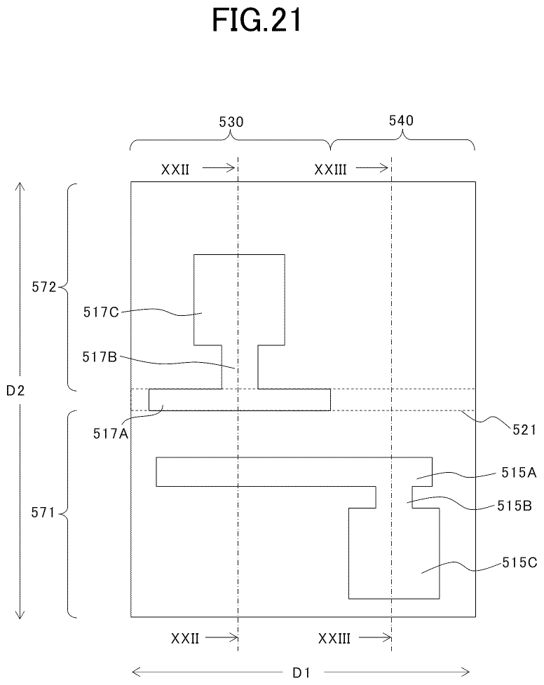

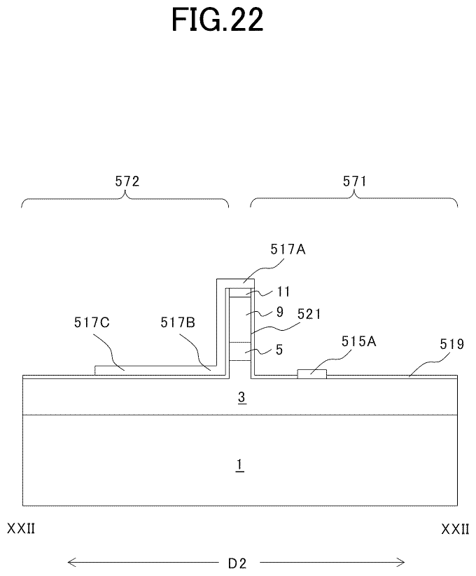

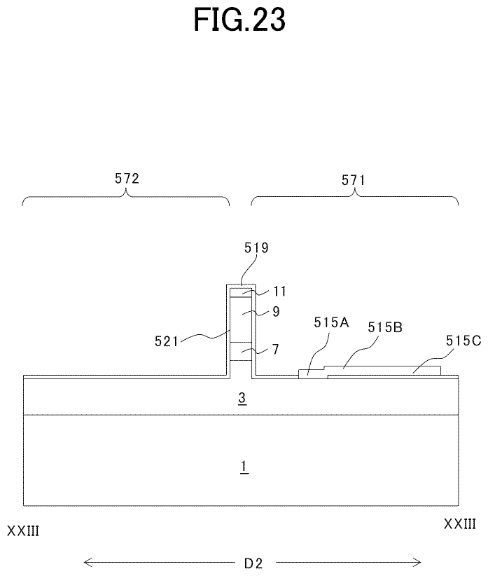

FIG. 21 is a top view of an optical semiconductor device according to a fifth example implementation of the present invention. FIG. 22 is a cross-sectional view for schematically illustrating a cross section taken along the line XXII-XXII of FIG. 21. FIG. 23 is a cross-sectional view for schematically illustrating a cross section taken along the line XXIII-XXIII of FIG. 21.

The fifth example implementation is different from the optical semiconductor device described in the first example implementation in that no buried layer is arranged on both side surfaces of a mesa structure 521. In the optical semiconductor device according to the fifth example implementation, an insulating film 519 may be arranged on both side surfaces of the mesa structure 521 in the second direction D2. The insulating film 519 may be arranged so as to cover the surface of the optical semiconductor device except for a part of an upper surface of the mesa structure 521 and a part of a first region 571 of a modulator unit 530.

A first electrode 515 may include a first connection electrode 515A connected to the first conductivity type semiconductor layer 3 in a region in which no insulating film 519 is arranged in the first region 571. A first bridge electrode 515B and a first pad electrode 515C may be arranged in a region of a waveguide unit 540 in plan view. A second electrode 517 may include a second connection electrode 517A connected to the second conductivity type contact layer 11 on the upper surface of the mesa structure 521. A second pad electrode 517C may be arranged in a second region 572. A second bridge electrode 517B may be connected to the second pad electrode 517C via the side surface of the mesa structure 521. Also in the optical semiconductor device including no buried layer as described in the fifth example implementation, at least a part of one pad electrode may be arranged in the waveguide unit 540. Thus, at the time of connection to the differential transmission line, a difference between wire lengths may be reduced, and the two wires may be arranged substantially parallel to each other. Here, a resin layer may be arranged below a part of the second bridge electrode 517B and the second pad electrode 517C. For example, a resin layer may be arranged in the second region 572 so as to be adjacent to the mesa structure 521, and the second bridge electrode 517B and the second pad electrode 517C may be arranged thereon. The arrangement of the resin layer allows a parasitic capacitance caused by the second electrode 517 to be reduced.

The first pad electrode 515C may be arranged in the second region 572. In this case, the first bridge electrode 515B may be connected to the first pad electrode 515C from the first region 571 via both the side surfaces of the mesa structure 521.

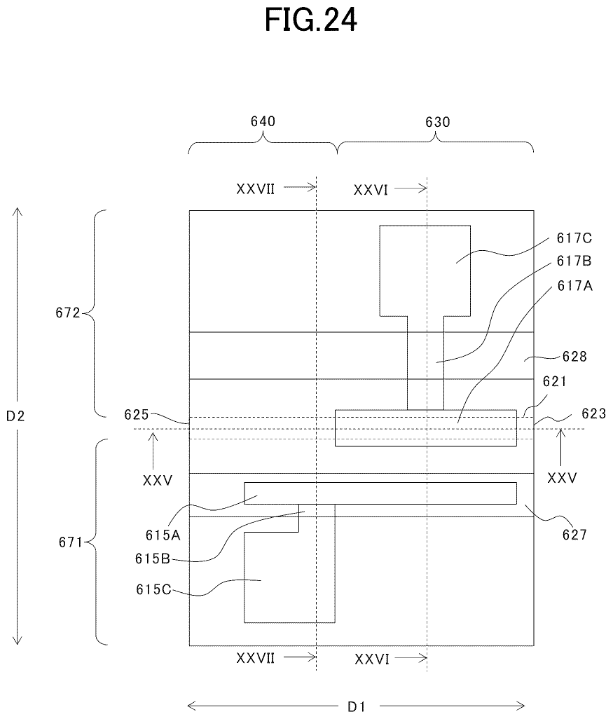

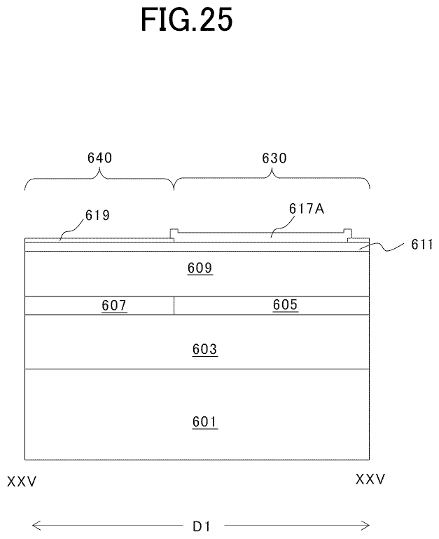

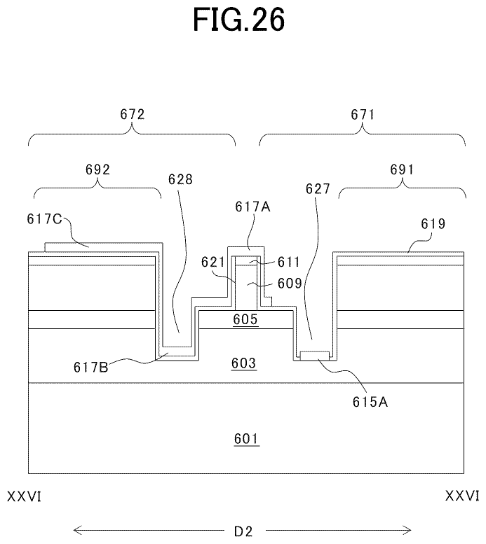

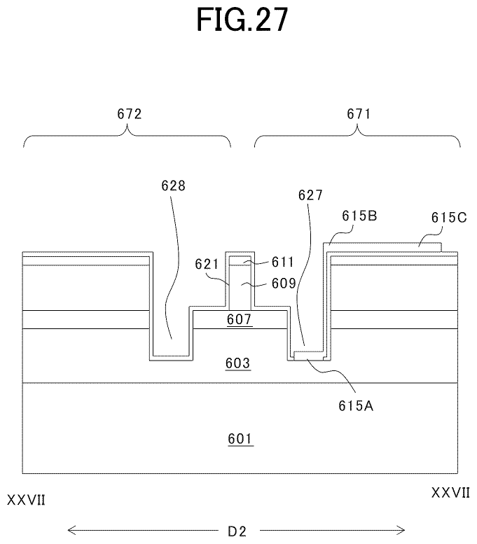

FIG. 24 is a top view of an optical semiconductor device according to a sixth example implementation of the present invention. FIG. 25 is a cross-sectional view for schematically illustrating a cross section taken along the line XXV-XXV of FIG. 24. FIG. 26 is a cross-sectional view for schematically illustrating a cross section taken along the line XXVI-XXVI of FIG. 24. FIG. 27 is a cross-sectional view for schematically illustrating a cross section taken along the line XXVII-XXVII of FIG. 24.

In the optical semiconductor device according to the sixth example implementation, a modulator unit 630 and a waveguide unit 640 may be arranged on a substrate 601 integrally. The modulator unit 630 generates a high-frequency optical signal in accordance with an applied high-frequency electric signal, and outputs the high-frequency optical signal to the waveguide unit 640 side. The modulator unit 630 may be a direct-modulation semiconductor laser. The waveguide unit 640 propagates the transmitted optical signal to a second facet 625. A first facet 623 may have an insulating film functioning as a high reflection film arranged thereon (not shown). Further, the second facet 625 may have an insulating film functioning as a low reflection film arranged thereon (not shown).

The modulator unit 630 may include, on the substrate 601, a first conductivity type semiconductor layer 603, an optical functional layer 605, a second conductivity type semiconductor layer 609, and a second conductivity type contact layer 611. Here, the substrate 601 may be an insulating (semi-insulating) semiconductor substrate. In this case, the first conductivity type semiconductor layer 603 may be an n-type semiconductor layer, and functions as a cladding layer and a layer for contact to a first electrode 615 to be described herein. The first conductivity type semiconductor layer 603 may include a plurality of layers. The optical functional layer 605 includes at least multiple quantum wells. In this case, the optical functional layer 605 functions as an active layer for generating light in accordance with the applied voltage. In this case, the second conductivity type semiconductor layer 609 may be a p-type semiconductor layer, and functions as a cladding layer. The second conductivity type semiconductor layer 609 may include a plurality of layers. The second conductivity type contact layer 611 may be a semiconductor layer connected to a second electrode 617 to be described herein. The conductivity of the second conductivity type contact layer 611 may be higher than the conductivity of the second conductivity type semiconductor layer 609, and the second conductivity type contact layer 611 may be arranged so as to reduce a contact resistance between the second electrode 617 and the semiconductor layer. The second conductivity type contact layer 611 is not required to be arranged. Further, another layer may be included between the first conductivity type semiconductor layer 603 and the optical functional layer 605 and/or between the second conductivity type semiconductor layer 609 and the optical functional layer 605. For example, an optical confinement layer or a grating layer may be arranged. The modulator unit 630 may be an active region for generating a modulated optical signal in accordance with electric signals input to the first electrode 615 and the second electrode 617.

The waveguide unit 640 may include the first conductivity type semiconductor layer 603, the waveguide layer 607, the second conductivity type semiconductor layer 609, and the second conductivity type contact layer 611, which may be arranged on the substrate 601. The first conductivity type semiconductor layer 603 and the second conductivity type semiconductor layer 609 may be formed in the same layers as the modulator unit 630, but may be formed separately therefrom. Further, the second conductivity type contact layer 611 is not required to be arranged. The waveguide layer 607 may be multiple quantum wells or a bulk semiconductor layer. In this case, the waveguide layer 607 may be a bulk semiconductor layer having a refractive index higher than that of the first conductivity type semiconductor layer 603 or the second conductivity type semiconductor layer 609. Another layer may be included between the first conductivity type semiconductor layer 603 and the waveguide layer 607 and/or between the second conductivity type semiconductor layer 609 and the waveguide layer 607. For example, an optical confinement layer may be arranged. The waveguide unit 640 may be a passive region to which no electric signal is input. A boundary between the modulator unit 630 and the waveguide unit 640 may be defined by a butt joint interface between the optical functional layer 605 and the waveguide layer 607.

As illustrated in FIG. 26 and FIG. 27, the optical semiconductor device may include a mesa structure 621. The mesa structure 621 may include the second conductivity type semiconductor layer 609 and the second conductivity type contact layer 611. The optical functional layer 605 and the waveguide layer 607 may be arranged between the mesa structure 621 and the first conductivity type semiconductor layer 603. The optical semiconductor device of the sixth example implementation may be a ridge optical semiconductor device. The mesa structure 621 extends in the first direction D1. Similarly to the above, with respect to the mesa structure 621 serving as a boundary, in the second direction D2, a side on which a second pad electrode 617C to be described herein may be arranged may be referred to as “second region 672,” and a region on the opposite side may be referred to as “first region 671.”

The optical semiconductor device may include two trench portions that divide each of the optical functional layer 605 and the waveguide layer 607. The trench portion formed in the first region 671 may be referred to as “first trench portion 627,” and the trench portion formed in the second region 672 may be referred to as “second trench portion 628.” The two trench portions extend from the first facet 623 to the second facet 625. Bottom surfaces of the two trench portions may reach the first conductivity type semiconductor layer 603.

The optical semiconductor device may include a first bank portion 691. The first bank portion 691 may be arranged adjacent to the first trench portion 627 on a side opposite to the mesa structure 621 side. A semiconductor multilayer of the first bank portion 691 may have the same configuration as that of the mesa structure 621 and a portion below the mesa structure 621. Similarly, the optical semiconductor device may include a second bank portion 692. The second bank portion 692 may be arranged adjacent to the second trench portion 628 on a side opposite to the mesa structure 621 side. A semiconductor multilayer of the second bank portion 692 may have the same configuration as that of the mesa structure 621 and the portion below the mesa structure 621.

An insulating film 619 may be arranged on the surface of the optical semiconductor device except for a part of the surface. The insulating film 619 may not be arranged on an upper surface of the mesa structure 621 of the modulator unit 630 and a part of the bottom surface of the first trench portion 627.

The optical semiconductor device may include the first electrode 615. The first electrode 615 may include a first connection electrode 615A connected to the first conductivity type semiconductor layer 603 at a bottom portion of the first trench portion 627. Further, the first electrode 615 may include a first pad electrode 615C arranged on an upper surface of the first bank portion 691 and in the first region 671. The first pad electrode 615C may be arranged in the waveguide unit 640 in plan view. The first connection electrode 615A and the first pad electrode 615C may be connected to each other by a first bridge electrode 615B.

The optical semiconductor device may include the second electrode 617. The second electrode 617 may include a second connection electrode 617A connected to the second conductivity type contact layer 611 at a upper surface of the mesa structure 621. Further, the second electrode 617 may include a second pad electrode 617C arranged on an upper surface of the second bank portion 692 and in the second region 672. The second connection electrode 617A and the second pad electrode 617C may be connected to each other by a second bridge electrode 617B. The second bridge electrode 617B may be arranged also on an inner side of the second trench portion 628.

Unlike the other example implementations, the modulator unit 630 itself emits light to generate a high-frequency optical signal. At this time, similarly to the other example implementations, when at least one pad electrode is arranged in the waveguide unit and two pad electrodes are arranged with an offset in positions in the traveling direction of the optical path of the waveguide unit, the effects described above may be obtained. As the arrangement of the pad electrode, those in the modification examples of the other example implementations may be applied. Further, description may have been given here of an example in which the optical signal is output from the second facet 625 side, but the present invention may not be limited thereto. Reflection films of the two facets may be appropriately selected so that the optical signal may be output from the first facet 623 side.

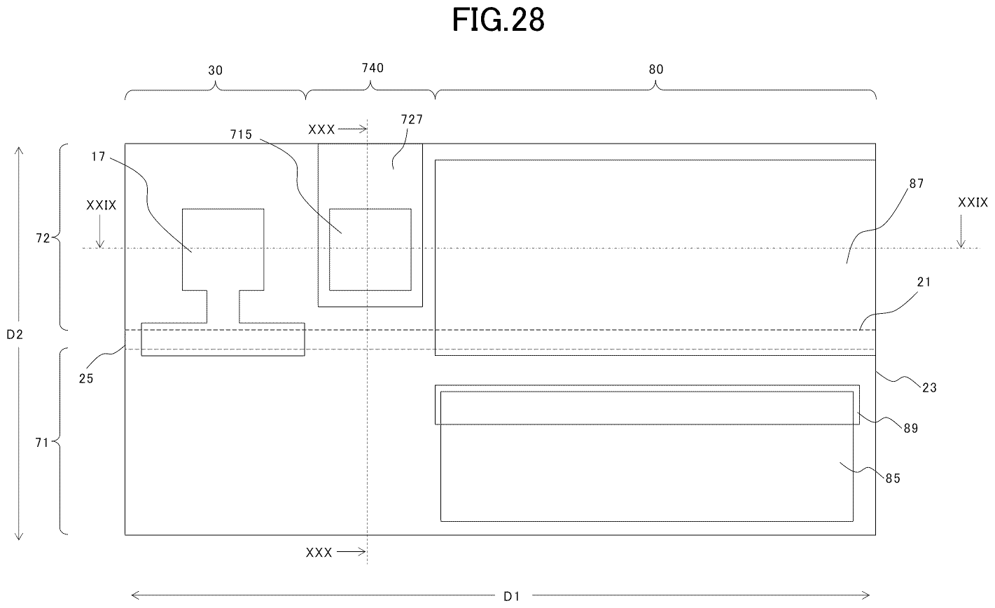

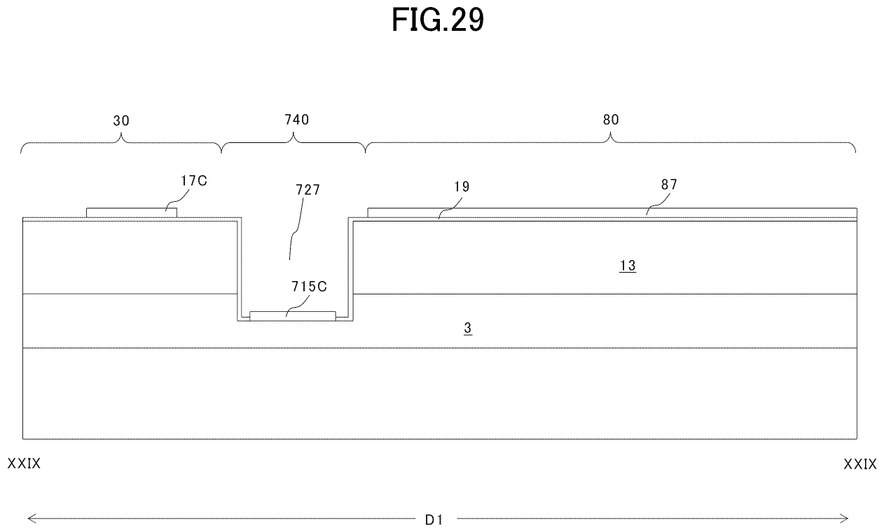

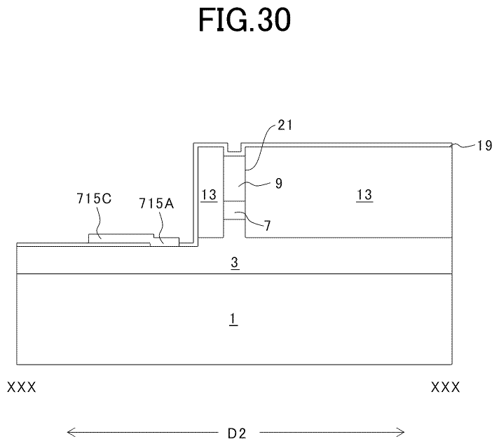

FIG. 28 is a top view of an optical semiconductor device according to a seventh example implementation of the present invention. FIG. 29 is a cross-sectional view for schematically illustrating a cross section taken along the line XXIX-XXIX of FIG. 28. FIG. 30 is a cross-sectional view for schematically illustrating a cross section taken along the line XXX-XXX of FIG. 28.

In the optical semiconductor device, the modulator unit 30, a waveguide unit 740, and the semiconductor laser unit 80 may be integrated on the substrate 1 integrally. The seventh example implementation may be mainly different from the second example implementation in the structures of the waveguide unit 740 and a first electrode 715. In the optical semiconductor device according to the seventh example implementation, the mesa structure may be a buried typed semiconductor layer buried in a semiconductor layer.

Here, a trench portion 727 having a bottom surface reaching the first conductivity type semiconductor layer 3 may be arranged in the waveguide unit 740. Unlike other example implementations and modification examples, the trench portion 727 may have a size that includes the entire first electrode 715. In other words, the entire first electrode 715 may be arranged on a bottom surface of the trench portion 727. The insulating film 19 may be arranged in a part between the bottom surface of the trench portion 727 (exposed surface of the first conductivity type semiconductor layer 3) and the first electrode 715. A region of the first electrode 715 directly connected to the first conductivity type semiconductor layer 3 on the bottom surface of the trench portion 727 may be a first connection electrode 715A. A region having the same width in the first direction D1 as the first connection electrode 715A and extending in the second direction D2 from the first connection electrode 715A may be a first pad electrode 715C. A first bridge electrode 715B may not be practically arranged, but it may be said that a region between the first connection electrode 715A and the first pad electrode 715C arranged on the insulating film 19 is the first bridge electrode 715B.

Here, the entire trench portion 727 may be arranged in the waveguide unit 740, but a part thereof may be arranged in the modulator unit 30. Further, as illustrated in FIG. 29 and FIG. 30, one end of the trench portion 727 reaches a side surface of the optical semiconductor device. The present invention is not limited thereto, and the trench portion 727 may be a dug portion that may have the semiconductor layer (in this case, the buried layer 13) on four sides. The difference from other example implementations of the buried type semiconductor layer resides in that the first pad electrode may be arranged in the trench portion.

As described above, in the optical semiconductor device including the optical

functional layer for generating an optical signal in accordance with an electric signal applied from outside, at least one of the two pad electrodes provided for transmitting electric signals to the optical functional layer may be arranged in the waveguide unit optically connected to the optical functional layer. Moreover, the two pad electrodes may be arranged with an offset in positions in the traveling direction of the optical path of the waveguide unit. Thus, a satisfactory connection state with the differential transmission line may be achieved, and excellent characteristics may be achieved. The optical functional layer may be a light absorption layer or an active layer for emitting light. Further, description has been given of a buried type optical semiconductor device in which the entire side surface of the mesa structure is covered with a semiconductor layer, but the present invention is not limited thereto. A buried type optical semiconductor device of a PBH type in which the second conductivity type semiconductor layer may be arranged on the mesa structure and the buried layer may be employed. In the above-mentioned example implementations, description may have been given assuming that the first conductivity type is the “n” type and the second conductivity type is the “p” type, but the present invention is not limited thereto. The first conductivity type may be the “p” type and the second conductivity type may be the “n” type.

According to the present invention, in the optical semiconductor device in which the two electrodes electrically continuous with the optical functional layer are arranged on the same surface side of the semiconductor substrate, high-frequency characteristics may be improved at the time of differential drive. The example implementations of the present invention achieve this effect as follows. The modulator unit and the waveguide unit may be integrated on the same substrate, a part of at least one electrode out of the two electrodes for operating the optical functional layer included in the modulator unit may be arranged in the waveguide unit in plan view, and the two pad electrodes may be arranged with an offset in positions in the traveling direction of the optical path of the waveguide unit. The two electrodes include pad electrodes for electrical connection to the outside, and the pad electrodes do not overlap each other in a second direction perpendicular to a direction (first direction) in which the light may be transmitted. Accordingly, electric wiring lines (wires or transmission lines) to be connected to the respective two pad electrodes may be connected substantially parallel to each other to the two pad electrodes. For example, when wires are used for connection, the two wires are wired in parallel to each other, and hence electric signals can be applied to the optical semiconductor device under a state of having an excellent noise immunity and suppressing the deterioration of the high-frequency electric signal. The optical semiconductor device may include the mesa structure, and the first region and the second region with respect to the mesa structure. The two pad electrodes may be arranged in the second region, or may be arranged separately in the first region and the second region. Out of the two pad electrodes, one to be arranged in the waveguide unit may be at least a part of the first pad electrode connected to the first conductivity type semiconductor layer or at least a part of the second pad electrode connected to the second conductivity type semiconductor layer. Light may be input to the facet on the waveguide unit side, or light may be output therefrom. The modulator unit may be an electro-absorption modulator or a direct-modulation semiconductor laser. Further, in the optical semiconductor device, the electro-absorption modulator, the waveguide, and the semiconductor laser may be integrated integrally. The two pad electrodes may be connected to the outside by wires or may be directly bonded to the wiring lines formed on the submount. A dummy pad electrode may be arranged in a region in which the two pad electrodes are not arranged.

While there have been described what are at present considered to be example implementations of the invention, it will be understood that various modifications may be made thereto, and it is intended that the appended claims cover all such modifications as fall within the true spirit and scope of the invention.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An optical semiconductor device, comprising:
a modulator unit including a first conductivity type semiconductor layer, an optical functional layer, and a second conductivity type semiconductor layer which are provided above a substrate;
a waveguide unit which is optically connected to the modulator unit, and is arranged integrally in the substrate;
a first electrode connected to the first conductivity type semiconductor layer; and
a second electrode connected to the second conductivity type semiconductor layer,
wherein the first electrode includes a first pad electrode to and/or from which an electric signal of one of a pair of differential signals is to be input and/or output,
wherein the second electrode includes a second pad electrode to and/or from which an electric signal of another one of the pair of differential signals is to be input and/or output,
wherein one of at least a part of the first pad electrode or at least a part of the second pad electrode is arranged in the waveguide unit in plan view, and
wherein the first pad electrode and the second pad electrode are arranged with an offset in positions in a traveling direction of an optical path of the waveguide unit.

2. The optical semiconductor device according to claim 1,
wherein one of the optical functional layer or the second conductivity type semiconductor layer forms a mesa structure,
wherein the optical semiconductor device further comprises a first region and a second region across the mesa structure in a second direction orthogonal in plan view to a first direction in which the mesa structure extends, and
wherein the second pad electrode is arranged in the second region.

3. The optical semiconductor device according to claim 2, wherein the first pad electrode is arranged in the second region.

4. The optical semiconductor device according to claim 3,
wherein at least a part of the first pad electrode is arranged in the waveguide unit, and
wherein at least a part of the second pad electrode is arranged in the modulator unit.

5. The optical semiconductor device according to claim 4, further comprising:
a buried layer on both sides of the mesa structure in the second direction; and
a trench portion in which the first conductivity type semiconductor layer is exposed from the buried layer,
wherein the first electrode is connected to the first conductivity type semiconductor layer in the trench portion.

6. The optical semiconductor device according to claim 5,
wherein the trench portion is arranged in the first region, and
wherein the trench portion is arranged in a region across the modulator unit and the waveguide unit in plan view.

7. The optical semiconductor device according to claim 5,
wherein the trench portion is arranged in the second region, and
wherein the trench portion is arranged in a region across the modulator unit and the waveguide unit in plan view.

8. The optical semiconductor device according to claim 7, wherein the trench portion is different from the second pad electrode in a position in the second direction.

9. The optical semiconductor device according to claim 7,
wherein the second electrode includes:
a second connection electrode which is arranged above the mesa structure, and is electrically connected to the second conductivity type semiconductor layer; and
a second bridge electrode provided between the second connection electrode and the second pad electrode, and
wherein the trench portion overlaps the second bridge electrode in plan view.

10. The optical semiconductor device according to claim 3, further comprising:
a first dummy electrode arranged in the waveguide unit in the first region; and
a second dummy electrode arranged in the modulator unit in the first region,
wherein the first dummy electrode and the second dummy electrode are electrically insulated from the optical functional layer.

11. The optical semiconductor device according to claim 2, wherein the first pad electrode is arranged in the first region.

12. The optical semiconductor device according to claim 11,
wherein at least a part of the first pad electrode is arranged in the waveguide unit, and
wherein at least a part of the second pad electrode is arranged in the modulator unit.

13. The optical semiconductor device according to claim 11,
wherein at least a part of the first pad electrode is arranged in the modulator unit, and
wherein at least a part of the second pad electrode is arranged in the waveguide unit.

14. The optical semiconductor device according to claim 11, further comprising:
a buried layer on both sides of the mesa structure in the second direction; and
a trench portion in which the first conductivity type semiconductor layer is exposed from the buried layer,
wherein the trench portion is arranged in the first region,
wherein the trench portion is arranged in a region across the modulator unit and the waveguide unit, and
wherein the first electrode is connected to the first conductivity type semiconductor layer in the trench portion.

15. The optical semiconductor device according to claim 3, further comprising:
a first dummy electrode arranged in the waveguide unit in the second region; and
a second dummy electrode arranged in the modulator unit in the first region,
wherein the first dummy electrode and the second dummy electrode are electrically insulated from the optical functional layer.

16. The optical semiconductor device according to claim 1, further comprising, on a side of the waveguide unit opposite to the modulator unit, a semiconductor laser unit which is optically connected to the waveguide unit and is integrated in the substrate.

17. The optical semiconductor device according to claim 1, further comprising, on a side of the modulator unit opposite to the waveguide unit, a second waveguide unit which is optically connected to the modulator unit and is integrated in the substrate,
wherein at least a part of the first pad electrode is arranged in the waveguide unit, and
wherein at least a part of the second pad electrode is arranged in the second waveguide unit.

18. The optical semiconductor device according to claim 1,
wherein one of the optical functional layer or the second conductivity type semiconductor layer forms a mesa structure, and
wherein the first pad electrode and the second pad electrode are different from each other in positions in a second direction orthogonal in plan view to a first direction in which the mesa structure extends.

19. The optical semiconductor device according to claim 1, wherein the optical functional layer is configured to absorb light or oscillate light in accordance with an electric signal applied between the first electrode and the second electrode.

20. The optical semiconductor device according to claim 1, wherein at least a part of the waveguide unit is a window structure free from a mesa structure.
